(19) United States
(12) Patent Application Publication
(10) Pub. No.: US 2005/0272495 A1
(43) Pub. Date: Dec. 8, 2005

(54) Game show system and method for conducting same

(76) Inventors: Joseph Penner, Santa Monica, CA (US); Ethan Penner, San Diego, CA (US)

Correspondence Address: FOLEY & LARDNER, P.O. BOX 80278, SAN DIEGO, CA, 92138-0278, US

(21) Appl. No.: 10/859,869

(22) Filed: Jun. 2, 2004

(51) Int. Cl. G06F 17/00; G06F 19/00

(52) U.S. Cl. 463/1

(57) ABSTRACT

A method for conducting a game and a game show system are disclosed. The method includes presenting an investment opportunity from each of a plurality of contestants to a mass-media audience, and determining one or more winning investment opportunities from the investment opportunities presented. The winning investment opportunity has a potential to receive an investment commitment.

### BACKGROUND OF THE INVENTION

The present invention relates generally to the field of game shows and, more particularly, to reality-based game shows.

### SUMMARY OF THE INVENTION

The disclosed embodiments provide an efficient and entertaining way for raising funds for a business venture or other investment opportunity. Investment funds are awarded to a contestant participating in a game which may be organized in a game-show format. Contestants are allowed to present an investment opportunity to a mass-media audience, such as a television audience or an Internet audience. One or more winners may be determined based on, for example, votes received from members of the audience or evaluations by a panel of experts. The votes from members of the mass-media audience may be accompanied by a commitment to invest by the voting members. Additional investment funds may be provided by organizers of the game.

One embodiment of the invention relates to a method for conducting a game. The method includes presenting an investment opportunity from each of a plurality of contestants to a mass-media audience, and determining one or more winning investment opportunities from the investment opportunities presented. The winning investment opportunities have a potential to receive an investment commitment.

As used herein, “conducting” includes the acts of operating, managing, producing or participating in a game show.

A “game” refers to a competition or entertainment activity. The game may be conducted according to a predetermined set of rules or regulations.

As used herein, “presenting” includes providing access, displaying or offering. Investment opportunities may be presented through a variety of ways such as slide show, video, audio and still images. The presentation of an investment opportunity may be in the form of a business plan. Presentations may also include other manners of conveying a concept, such as using video footage to illustrate an operation or activities.

An “investment opportunity” includes an opportunity to invest funds to further a venture, for example. The venture may be either for-profit or not-for-profit.

“Contestants” may include individuals, groups of individuals, or artificial entities such as corporations or partnerships.

“Mass-media audience,” as used herein, includes members of the general public and may include television viewers and users of public electronic networks such as the Internet.

An “investment commitment” includes a commitment to provide funds as investment in an investment opportunity.

In a particular embodiment, the method includes soliciting votes from members of the mass-media audience.

“Soliciting” includes offering an opportunity or requesting participation in an activity.

“Votes” include an indication of a preference for one in a group of options. The preference may be based on any of a number of factors. For example, a preference for an investment opportunity may be based on a prediction of success and a profitable future.

In another embodiment, a game-show system includes a plurality of contestants and an investment fund. The contestants each have an investment opportunity to present to a mass-media audience. The investment fund is to be awarded to one or more winning investment opportunities selected from the investment opportunities presented by the contestants.

In a particular embodiment, the winning investment opportunity is determined according to voting by the mass-media audience. The investment fund is based at least partially on votes from members of the mass-media audience.

### BRIEF DESCRIPTION OF THE DRAWINGS

FIG. 1 is a diagrammatic illustration of a game show system according to one embodiment;

FIG. 2 is a diagrammatic illustration of a game show system according to another embodiment;

FIG. 3 is a diagrammatic illustration of a game show system according to still another embodiment; and

FIG. 4 is a flow chart illustrating an embodiment of a method of conducting a game.

### DETAILED DESCRIPTION OF THE PREFERRED EMBODIMENTS

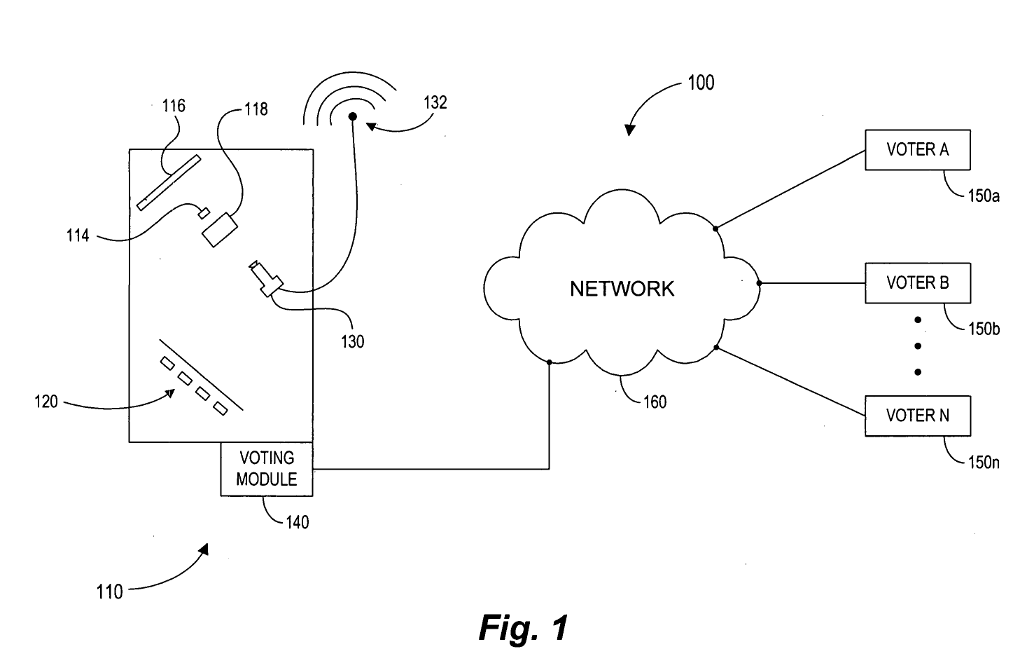

Referring to FIG. 1, an embodiment of a game show system is illustrated. The game show system 100 includes a game show platform 110 on which a game may be conducted. The platform 110 includes a contestant section 112 to allow contestants, such as contestant 114, to present an investment opportunity. The investment opportunities may be presented as business plans in, for example, a multi-media format. In this regard, the contestant section 112 may be provided with a screen or a monitor 116 on which presentation slides or a video may be presented to describe each investment opportunity. A podium 118 may also be provided to assist each contestant in his presentation.

A contestant may be an individual, a group of individuals or another entity, such as a corporation or a partnership. The contestant may be represented by a single individual during the presentation of the investment opportunity.

As noted above, the investment opportunities may be presented in any of a number of ways. In one embodiment, an investment opportunity includes a business plan which is presented through a multi-media presentation. In this regard, the presentation may include, for example, a set of slides explaining the business plan. In one embodiment, a summary of the business plan may be presented through the slides, while a detailed explanation may be provided as a hard copy or electronic report made available through, for example, mail or an electronic medium. For example, the detailed report may be provided on a compact disc or may be made available on a server accessible through an electronic network such as the Internet. Presentations may also include other manners of conveying a concept, such as using video footage to illustrate an operation or activities. For example, video footage may show a contestant engaged in activities relating to an investment opportunity.

A panel of experts 120 is situated on the platform 110 to provide an individual evaluation of each investment opportunity. The experts may be chosen for their expertise, reputation or trustworthiness in evaluation of investment opportunities. Preferably, the experts are chosen from a group of successful investors or entrepreneurs who have achieved credibility through demonstration of their ability to recognize lucrative investment opportunities. The number of experts on the panel 120 may be selected to provide a sufficient variety of viewpoints. Although the embodiment illustrated in FIG. 1 shows a panel of four experts, any practical number of experts may be selected.

The platform 110 may also include studio equipment, including a camera 130 and a transmitter 132, to deliver the presentation and evaluation of the investment opportunities to a mass-media audience. The delivery may be achieved through any number of ways, including broadcast over public airwaves for television viewing or radio listening, or through a cable or satellite system for reception by a group of subscribers.

In one embodiment, the presentation and evaluation of the investment opportunities is delivered live to the mass-media audience. As used herein, “live” refers to delivering substantially in real time. “Live” may include a small delay in delivery, as is common to allow censoring or editing of certain aspects. In other embodiments, the presentation and the evaluation of the investment opportunities are taped for delivery to a mass-media audience at a later time.

In certain embodiments, the platform 110 also includes a studio audience (not shown in FIG. 1). The studio audience may include lay persons seeking entertainment or investment opportunities.

The platform 110 includes a voting module 140 adapted to receive and tabulate votes from members of the mass-media audience. The voting module 140 may be physically situated apart from the other components of the platform 110. For example, the platform 110 may be situated in a communications facility adapted to receive votes through a network 160. The network 160 may be a communication network such as the public switched telephone network (PSTN) for telephone voting, an electronic network such as the Internet, or a combination thereof.

Thus, in operation, a plurality of contestants 114 may present investment opportunities to the panel of experts 120 and to the mass-media audience. When the presentations are delivered to the mass-media audience, one or more of the investment opportunities is determined to be a winning investment opportunity. The determination may be made solely by the producers of the game. In one embodiment, the determination of the winning investment opportunities is made according to evaluations by the panel of experts.

In another embodiment, the determination may be made by members of the audience who elect to vote on one of the presented investment opportunities. The voting members 150a-n of the mass-media audience may submit their votes in a variety of manners, including mail, telephone, and e-mail.

In one embodiment, the voting members 150a-n submit their votes through the network 160 to the voting module 140 for tabulation. The votes may be submitted through a touch-tone telephone system, an electronic mail system or a web site through the Internet, for example.

The votes by the voting members 150a-n of the mass-media audience may not only specify the preferred investment opportunity, but also include a commitment to invest in the preferred investment opportunity. The commitment to invest may specify an investment level such as $10, $100, $1000 or more.

The votes are received and tabulated by the voting module 140. The designation of the winner may be based on such factors as the number of votes received. In one embodiment, each vote received is weighted according to the size of the commitment to invest from the voting member of the mass-media audience. Thus, a vote with a $10-commitment may be weighted to be one-half of a vote with a $20-commitment. The tabulation of the votes designates one of the contestants as the winner and the corresponding investment opportunity as the winning investment opportunity.

The winner receives an investment commitment in the investment opportunity from a fund. The fund may include commitments from the voting members of the audience, as well as additional funds committed by, for example, the organizers of the game or the panel of experts. The commitments from the voting members may be included only from those voting members who voted for the winning investment opportunity. For example, if a member of the mass-media audience votes for contestant A but contestant B is determined to be the winner, that voting member's commitment is not included in the fund.

The fund may be either public or private and may be required to satisfy various regulatory or legal requirements. For example, in one embodiment, the fund is a public offering registered with the United States Securities and Exchange Commission (SEC). Such registration with the SEC can facilitate the offering to the mass-media audience through, for example, television, telephone, Internet and others. In one embodiment, the fund is registered with the SEC as a closed-end fund. Of course, many other types of funds are possible and are contemplated within the scope of the invention.

In one embodiment, a single winner or winning investment opportunity is determined from a group of contestants and investment opportunities. Thus, for example, at the end of a program, a winner may be designated according to evaluations by the panel or votes by members of the mass-media audience. In another embodiment, several rounds of elimination may be used to determine the eventual winner. For example, the program may be organized in several sessions, with each session being used to eliminate one or more contestants to reduce the number of contestants and investment opportunities still having a potential to receive an investment commitment.

The game may be organized according to specific investment types. For example, in one game, the contestants each present an investment opportunity related to real estate, while in another game, the contestants each present an investment opportunity related to a specific technology, such as software.

In another embodiment, the presentation of the investment opportunities and the determination of the winning investment opportunity may be made available to the mass-media audience for betting in a manner similar to pari-mutuel betting. In this regard, once each contestant has presented an investment opportunity, members of the mass-media audience may place wagers on one or more of the presented investment opportunities. The wagers may be received through the network 160 and the voting module 140. The amount of each wager may be determined solely by the individual member of the audience. Restrictions, such as maximum or minimum wagered amount, may be placed on each wager by the administrators or producers of the contest. The panel of experts 120 may then determine one or more winning investment opportunities. Those members who had wagered on an investment opportunity that is determined to be a winning investment opportunity may then be awarded winnings determined based on such factors as the amount wagered by the individual member, total amount wagered by all members, and total amount wagered on the particular winning investment opportunity.

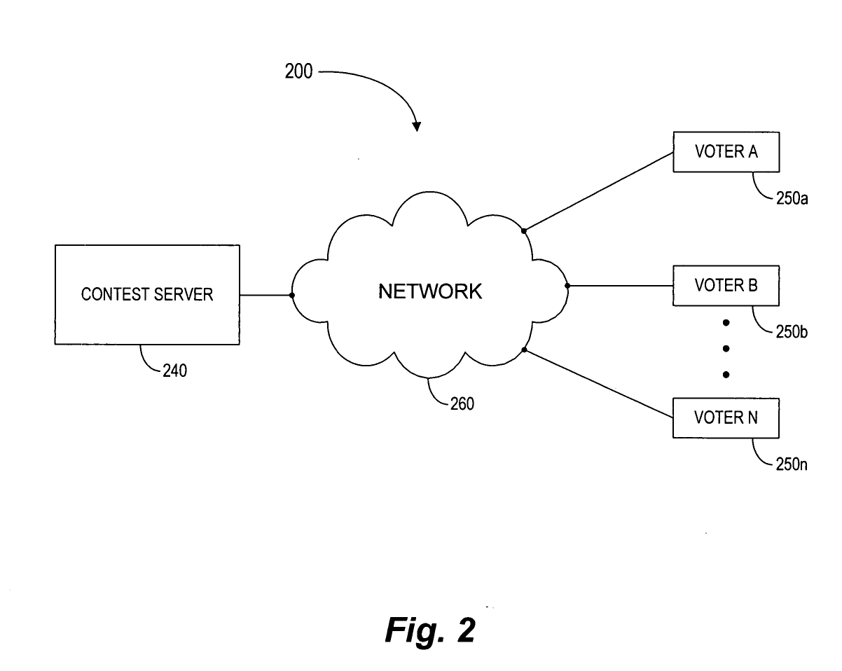

FIG. 2 illustrates another embodiment of a game show. In this embodiment, the game is conducted by presenting investment opportunities to a mass-media audience through a public network, such as the Internet. In this regard, the game show system 200 includes a contest server 240 accessible to audience members 250a-n through a network 260. The contest server 240 may include one or more servers or a network of servers. In one embodiment, the contest server 240 serves as a gateway to other servers (not shown) for accessing electronic data, as described below. The audience members 250a-n may access the network 260 and the contest server 240 through any of a variety of devices, including a desktop or laptop computer, a cellular telephone or a personal digital assistant, for example.

In this game show system 200, competing investment opportunities from a plurality of contestants may be presented to the audience members as electronic data on a website hosted on the contest server 240. In this regard, each investment opportunity may any combination of text, image, video and audio data. For example, an investment opportunity may be presented as a slide show accompanied by streaming audio data.

The electronic data for each investment opportunity may be located outside the contest server. For example, the data may be located on a data server connected to the Internet, and the contest server may provide a link to the data server. Thus, from the perspective of the audience member, only the web site hosted by the contest server is accessed.

Audience members 250a-n may view the investment opportunities at their convenience. Upon viewing one or more of the investment opportunities, audience members 250a-n may elect to vote on a preferred investment opportunity. As noted above with reference to FIG. 1, the votes may be accompanied by a commitment to invest and may be weighted accordingly. The votes may be tabulated by the contest server 240, which may be provided with the necessary software, hardware or firmware. A winner may be determined when a voting period has lapsed.

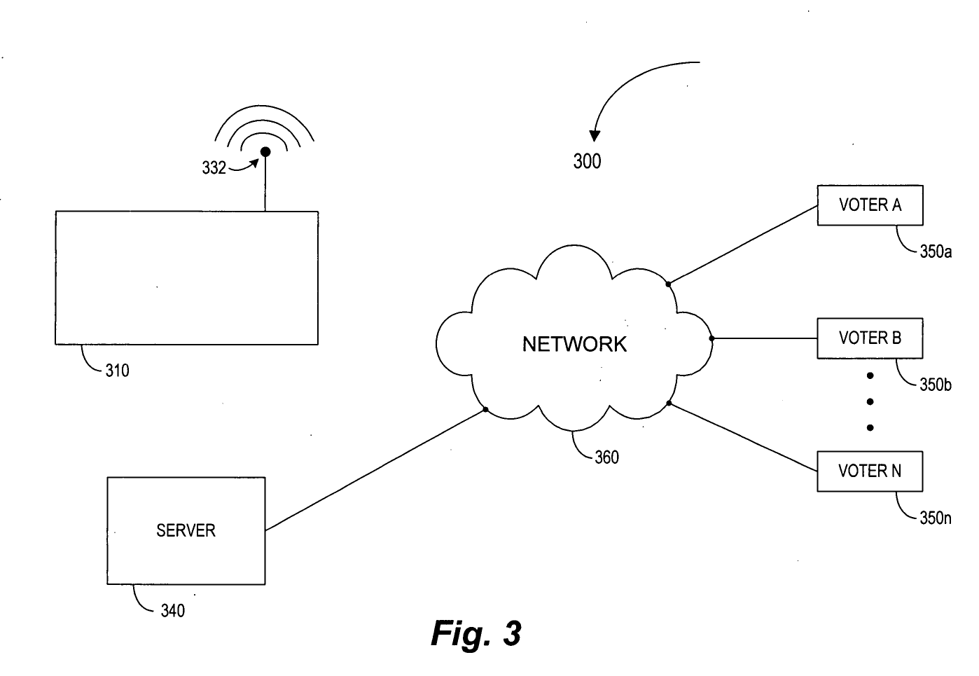

FIG. 3 illustrates another embodiment of a game show system. The illustrated game show system 300 includes a game show platform 310, similar to the game show platform 110 shown in FIG. 1. Presentations of competing investment opportunities may be delivered to a mass-media audience through, for example, broadcast by a transmitter 332. The presentations of the investment opportunities may be accompanied by information directing the audience to a web site hosted on a contest server 340 connected to a public network 360, such as the Internet. The server 340 may provide audience members who are interested in the investment opportunities, such as members 350a-n, with access to additional details on each investment opportunity, as well as the ability to vote on one of the investment opportunities. Again, the votes may be accompanied by an investment commitment by the voting audience members 350a-n.

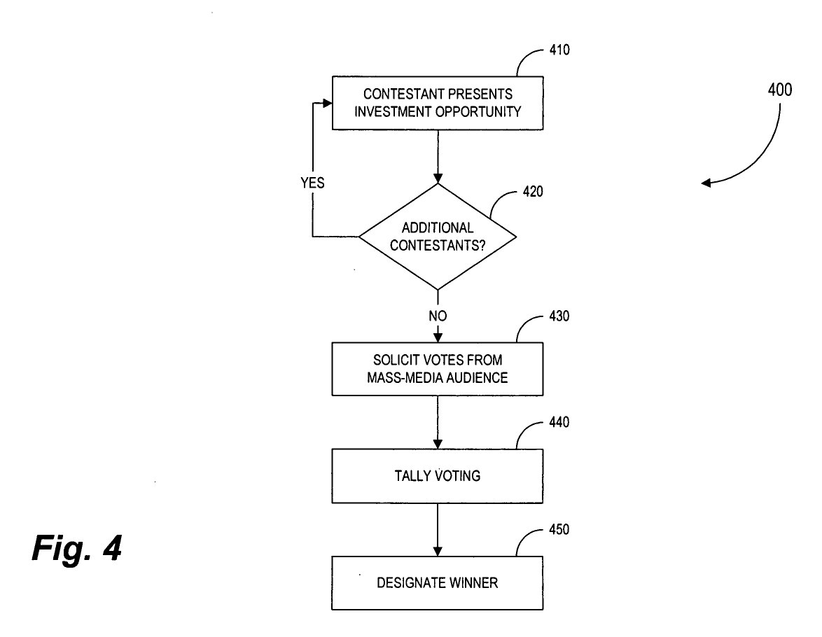

FIG. 4 is a flow chart illustrating an embodiment of a method of conducting a game. The method 400 includes presenting an investment opportunity by a contestant (block 410). As noted above, the investment opportunity may be presented in a variety of manners including a slide show, video or text. At block 420, a determination is made as to whether additional contestants remain for presenting an investment opportunity. If additional contestants remain, the method returns to block 410.

Once all contestants have presented an investment opportunity, votes are solicited from a mass-media audience (block 430). The votes may be solicited through any communication method such as telephone, e-mail, website, etc.

When all the votes have been received or the voting period has lapsed, the votes are tabulated (block 440). The tabulation of the votes may include accounting for weighting of the votes based on a commitment to invest accompanying each vote. Based at least partially on the results of the tabulation, a winner is designated from the group of contestants presenting investment opportunities (block 450).

Thus, the disclosed embodiments provide an efficient and entertaining systems and methods for raising funds for investment opportunities.

The foregoing description of embodiments of the invention has been presented for purposes of illustration and description. It is not intended to be exhaustive or to limit the invention to the precise form disclosed, and modifications and variation are possible in light of the above teachings or may be acquired from practice of the invention. The embodiments were chosen and described in order to explain the principles of the invention and its practical application to enable one skilled in the art to utilize the invention in various embodiments and with various modification as are suited to the particular use contemplated. It is intended that the scope of the invention be defined by the claims appended hereto and their equivalents

1. A method for conducting a game, comprising:
presenting an investment opportunity from each of a plurality of contestants to a mass-media audience; and
determining one or more winning investment opportunities from said investment opportunities presented, said winning investment opportunities having a potential to receive an investment commitment.

2. The method according to claim 1, wherein said step of determining includes:
soliciting votes from members of said mass-media audience.

3. The method according to claim 2, further comprising:
receiving said votes from said audience; and
designating at least one winner from said contestants based at least partially on the votes received.

4. The method according to claim 3, wherein said votes are representative of a commitment to invest in a contestant by said members of said audience.

5. The method according to claim 4, wherein said step of receiving includes weighting said votes based on a size of said commitment to invest.

6. The method according to claim 3, wherein said step of receiving includes receiving votes through a network.

7. The method according to claim 6, wherein said network is a telephone network.

8. The method according to claim 6, wherein said network is the Internet.

9. The method according to claim 1, further comprising:
presenting evaluations of said investment opportunity by a panel of one or more experts.

10. The method according to claim 9, wherein said step of determining is based on said evaluations by said panel.

11. The method according to claim 1, wherein said mass-media audience is a television audience.

12. The method according to claim 1, wherein said mass-media audience includes individuals on an electronic network.

13. The method according to claim 1, wherein said mass-media audience is an Internet audience.

14. The method according to claim 1, further comprising:
receiving wagers from wagering members of the mass-media audience on one or more of said investment opportunities prior to said determining one or more winning investment opportunities.

15. The method according to claim 14, further comprising:
awarding winnings to winning wagering members after said determining one or more winning investment opportunities, said winning wagering member having wagered on at least one of said winning investment opportunity.

16. The method according to claim 14, wherein said winnings are determined according to pari-mutuel betting.

17. A game show system, comprising:
a plurality of contestants each having an investment opportunity to present to a mass-media audience; and
an investment fund to be awarded to one or more winning investment opportunities, said winning investment opportunities being selected from said investment opportunities presented by said contestants.

18. The system according to claim 17, wherein said winning opportunities are determined according to voting by said mass-media audience, said investment fund being based at least partially on votes from members of said mass-media audience.

19. The system according to claim 18, wherein said votes are representative of a commitment to invest in a contestant by said members of said audience.

20. The system according to claim 19, wherein said votes are weighted based on a size of said commitment to invest.

21. The system according to claim 18, wherein said audience is adapted to vote through a network.

22. The system according to claim 21, wherein said network is a telephone network.

23. The system according to claim 21, wherein said network is the Internet.

24. The system according to claim 17, further comprising:
a panel of one or more experts for evaluating each investment opportunity.

25. The system according to claim 24, wherein said one or more winning opportunities are determined according to evaluations by said panel.

26. The system according to claim 17, wherein said mass-media audience is a television audience.

27. The system according to claim 17, wherein said mass-media audience includes individual on an electronic network.

28. The system according to claim 17, wherein said mass-media audience is an Internet audience.
